(19) United States
(12) Patent Application Publication
(10) Pub. No.: US 2019/0378538 A1
(43) Pub. Date: Dec. 12, 2019

(54) CONNECTED RECORDING MEDIUM DISC

(71) Applicant: MPO INTERNATIONAL, AVERTON (FR)

(72) Inventor: Sylvin DE MAGNIENVILLE, SAINT-PIERRE DES NIDS (FR)

(73) Assignee: MPO INTERNATIONAL, AVERTON (FR)

(21) Appl. No.: 16/545,266

(22) Filed: Aug. 20, 2019

Related U.S. Application Data
(63) Continuation of application No. PCT/FR2018/050414, filed on Feb. 22, 2018.

(30) Foreign Application Priority Data
Feb. 22, 2017 (FR) 17/51401

(51) Int. Cl. G11B 3/68; G06K 19/07

(52) U.S. Cl. CPC G11B 3/68; G06K 19/0723

(57) ABSTRACT

An analog recording medium disc includes a first face including a read layer and a first tag. The analog recording medium disc includes a radio-frequency identification device that includes a contactless electronic chip that is associated with an antenna. The antenna is printed directly on a face of the tag, and the tag is held within the material of the disc.

### CROSS-REFERENCE TO RELATED APPLICATIONS

This application is a continuation of International Application No. PCT/FR2018/050414, filed on Feb. 22, 2018, which claims priority to and the benefit of FR 17/51401 filed on Feb. 22, 2017. The disclosures of the above applications are incorporated herein by reference.

### FIELD

The present disclosure relates to a connected recording medium disc and the manufacturing method thereof. More particularly, the present disclosure concerns a microgroove disc called “vinyl disc.”

### BACKGROUND

The statements in this section merely provide background information related to the present disclosure and may not constitute prior art.

A microgroove disc generally has a first face and a second face which each include a read layer.

Each face of the disc supports a circular printed label that extends around a hole formed at the center of the disc.

The method for manufacturing a microgroove disc includes in particular a pressing step which includes in pressing a melting vinyl disc into a press by means of a die to form the disc.

The labels are generally interposed between the die and the melting vinyl disc at the time of pressing, so that the labels are held within the material that constitutes the disc.

Thus, the surface of the label is flush with the surface of the disc, without forming an over-thickness.

It is known to equip a microgroove disc with a radio frequency identification device to transform a simple disc into a connected disc.

The radio frequency identification device allows, for example, the user to connect via a smartphone-type equipment on a dedicated platform that proposes to listen to music, download music, access data on the artist, download discount coupons, etc.

The radio frequency identification is often designated by the acronym RFID “Radio Frequency IDentification,” and it allows remotely memorizing and retrieving data by using a radio frequency identification device.

Among the radio frequency identification devices, there are known the NFC devices for “Near Field Communication,” and the long-range devices.

The radio frequency identification device, also called “radio-label,” includes an antenna associated with an electronic chip, which allows the radio frequency identification device to receive requests and to respond to radio frequency requests emitted from a transceiver.

The transceiver is for example a mobile terminal like a smartphone or a touchpad.

In order to equip a disc with a radio frequency identification device, one could imagine a radio frequency identification device that is in the form of a sticker that is bonded on the disc label on the reverse side before pressing.

However, this type of sticker may not withstand the conditions of the disc manufacturing method, in particular those of the pressing.

One could also imagine manufacturing the disc conventionally and adding a radio frequency identification device by bonding a sticker on the disc label, front side, that is to say visible side.

But the radio frequency identification device, protruding relative to the label and the surface of the disc, could easily peel off, intentionally or not.

In addition, from an industrial point of view, adding an attached sticker requires a step of bonding the stickers on the disc label, before or after pressing, involving modifying the production machines.

### SUMMARY

The present disclosure provides an analog recording medium disc, such as a microgroove, that has at least one first face including at least one read layer and at least one first label, characterized in that it comprises at least one radio frequency identification device, the radio frequency identification device comprising at least one contactless electronic chip that is associated with an antenna, the antenna being printed directly onto a face of the label, and the label being held within the material that constitutes the disc.

The disc according to the present disclosure provides an integration between the radio frequency identification device, the label, and the disc.

In addition, the manufacture of such a disc is economical and little time-consuming.

Since the label is held within the material of the disc, it is not necessary to bond it.

According to another characteristic, the label has a front face which is visible by a user and a reverse face which is extended over the first face of the disc, the radio frequency identification device being arranged on the reverse face of the label.

This characteristic allows the radio frequency identification device to be protected on one side by the substrate of the label, and on the other by the vinyl substrate.

According to another characteristic, the radio frequency identification device uses a wireless communication technology of the near field communication type.

According to another characteristic, the disc comprises a plurality of radio frequency identification devices which each use a range of different radio frequencies to expand the possibilities of communication with the disc.

This characteristic allows having several types of communication between the disc and an associated terminal such as the near field and the long distance.

According to another characteristic, the label is a paper label.

The paper label allows printing a visual on the front face of the label.

According to another characteristic, the disc includes a second label which is arranged on a face of the disc opposite to the face which carries the first label, the second label being equipped with an additional radio frequency identification device.

This characteristic allows improving communication between the disc and an associated terminal.

According to another characteristic, the recording medium disc is a microgroove disc.

According to another characteristic, the disc is equipped with a protective case which includes at least one protective screen which is adapted to inhibit contactless communication between the radio frequency identification device of the label and an external device.

The present disclosure also concerns a method for manufacturing a disc of the type described above, the method comprises at least:

a step of manufacturing the label which comprises in particular a phase of depositing the radio frequency identification device on the label which includes printing the antenna onto the label and attaching the chip on the printed antenna;

a step of printing a visual on the label; and

a step of pressing the disc which includes pressing together a substrate forming the disc and the previously printed label.

The method according to the present disclosure allows printing the labels in batches by a standard printing tool and manufacturing the disc by a standard production tool to the production of a microgroove disc.

According to another characteristic, the method comprises a step of controlling and initializing the radio frequency identification device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a top view of a microgroove disc having a central label that is equipped with radio frequency identification devices according to the present disclosure;

FIG. 2 is a cross-sectional view of the disc along line 2-2 of FIG. 1;

FIG. 3 is a bottom view of the central label which illustrates the radio frequency identification devices printed on the central label of FIG. 1;

FIG. 4 is a detailed view of a radio frequency identification device for the disc of FIG. 1; and

FIG. 5 is a perspective view of a protective case in which the disc of FIG. 1 is inserted.

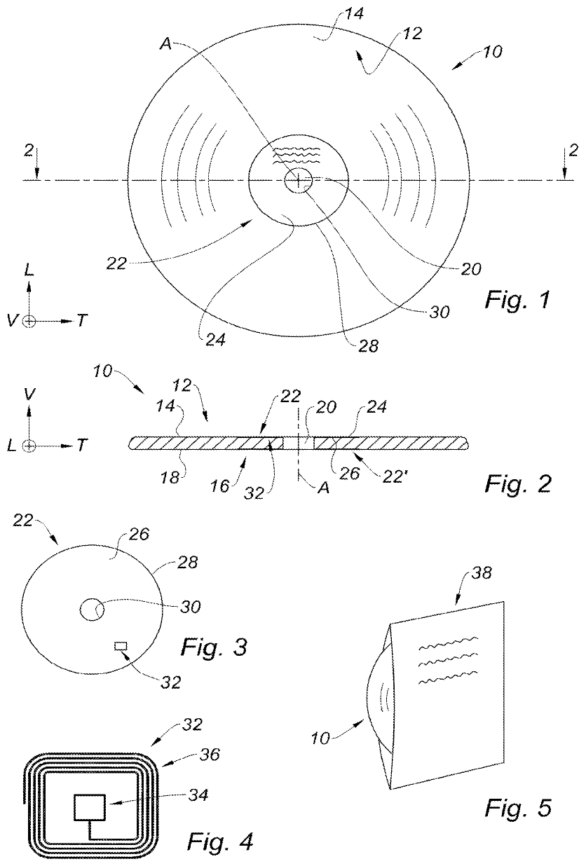

In the description and the claims, the expressions «upper» and «lower» and their derivatives will be used in a non-limiting manner with reference to the upper portion and the lower portion respectively of FIG. 1.

In addition, to clarify the description and the claims, the longitudinal, vertical and transversal terminology will be adopted in a non-limiting manner with reference to the L, V, T trihedron indicated in the figures.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 shows a recording medium disc 10 which extends in a horizontal plane, that is to say in longitudinal and transverse directions.

The disc 10 has a first upper face 12 which includes a first read layer 14 and a second opposite lower face 16 which has a second read layer 18.

The disc 10 is a microgroove disc which delimits at its center a hole 20 intended to cooperate with a centering pin of a record player (not shown).

As can be seen in FIGS. 1 and 2, the upper face 12 of the disc 10 supports a first label 22 which extends around the central hole 20 along a vertical axis A.

Similarly, the lower face 16 of the disc 10 supports a second label 22′ which extends around the central hole 20 along a vertical axis A.

The first label 22 is a disc-shaped paper label which has a first front face 24 visible by the user and a second reverse face 26 pressed against the upper face 12 of the disc 10.

Also, the label 22 is delimited by a first outer peripheral edge 28 and a second inner peripheral edge 30, each peripheral edge 28, 30 being circular-shaped around the central axis A.

In accordance with the present disclosure, the disc 10 comprises a radio frequency identification device 32 which is integrated on the reverse face 26 of the label 22.

The radio frequency identification device 32, one of which is shown in detail in FIG. 4, comprises a contactless electronic chip 34 that is associated with an antenna 36.

The antenna 36 is printed directly on the reverse face 26 of the label 22.

According to one form, the antenna 36 is printed on the label 22 by a suitable ink, for example, a silver-based ink.

However, the term “printed” is to be understood in the broad sense.

Indeed, the term “printed” also means that the antenna 36 can be printed by etching by acid attack in the manner of producing a printed circuit, or any other type of printing or etching.

Also, the electronic chip 34 is attached on the label 22 so as to be connected to the printed antenna.

More particularly, the radio frequency identification device 32 uses a wireless communication technology of the near field communication type.

The near field communication technology is known under the acronym NFC for “Near Field Communication.”

The radio frequency identification device 32 is designed to receive radio frequency requests and respond to radio frequency requests emitted from a transceiver (not shown).

The transceiver is for example a mobile terminal like a smartphone or a touchpad.

The label 22 of the disc 10 according to the present disclosure constitutes a “radio-label” as such, that is to say the label 22 constitutes a radio frequency identification device as such.

Referring to FIG. 5, the disc 10 is equipped with a protective case 38 which includes two protective screens adapted to inhibit contactless communication between the radio frequency identification device 32 arranged on the disc 10 label 22 and an external device.

The protective screens are for example each formed by an aluminum film, the protective screens each covering a large face of the protective case 38.

The present disclosure also concerns a method for manufacturing the previously described disc 10.

The manufacturing method essentially comprises a step of manufacturing the label 22 and a step of pressing the disc 10.

The label 22 manufacturing step comprises in particular a first phase of depositing the radio frequency identification device 32 on the reverse face 26 of the label 22 which includes printing the antenna 36 onto the label 22 and attaching the chip 34 on the printed antenna 36.

In addition, the label 22 manufacturing step comprises a second phase of printing the visual on the front face 24 of the label 22.

It will be noted that the second printing phase can be carried out before the first phase of depositing the radio frequency identification device 32.

Also during the label 22 manufacturing step, the label is cut in its final disc shape, by a die-cutting device for example.

Then, the label is dried by an oven-drying standard method.

The disc 10 pressing step is carried out according to a standard method, which includes pressing together a substrate forming the melting disc 10 and the two labels 22, 22′.

The labels 22, 22′ are interposed between the dies and the melting material at the time of pressing, such that the labels 22, 22′ are held within the material that constitutes the disc 10; no bonding is necessary.

Thus, the surface of the labels 22, 22′ are flush with the surface of the disc, without forming an over-thickness.

The method includes an optional step of controlling and initializing the radio frequency identification devices 32, which includes initializing the radio frequency identification devices 32 by a suitable read-write equipment, during or after the first phase of depositing the radio frequency identification device 32.

The disc 10 according to the present disclosure provides an integration of the radio frequency identification device 32.

This integration is obtained by depositing the radio frequency identification device 32 on the label 22 which withstands strong temperature constraints during oven-drying of the label 22, and strong pressure, friction and temperature constraints during pressing of the disc 10.

The radio frequency identification device 32 is encapsulated, on one side by the upper face 12 of the disc 10, and on the other side by the paper substrate which provides a protective function.

However, by way of a non-limiting example, depositing the radio frequency identification device 32 can be performed on the front side 24 of the label 22.

In addition, the disc 10 manufacturing method according to the present disclosure is compatible with the standard method for manufacturing the labels and the microgroove discs, without modifying the production tool and without increasing the manufacturing cycle time.

Finally, the additional cost of the manufacturing of the disc 10 according to the present disclosure compared to a “standard” microgroove disc is low; it is related to the additional cost of the quality of the label 22 paper which is used as a substrate for the radio frequency identification device and able to withstand the manufacturing constraints of the vinyl disc, and to the additional cost of the deposition of the radio frequency identification device.

According to one form of the present disclosure, the disc 10 includes several radio frequency identification devices.

For example, the disc 10 includes a first radio frequency identification device that uses the near field communication technology and a second radio frequency identification device that uses a long-distance communication technology.

According to this form, both radio frequency identification devices use different technologies to allow the disc 10 to communicate with different applications, the first device allowing, for example, to communicate with NFC-type applications via smartphone for relationship with the customer, the second device allowing to communicate with applications of the inventory management, traceability, antitheft type.

According to another form of the present disclosure, the first label 22 and the second label 22′ of the disc 10 each include a radio frequency identification device. These radio frequency identification devices can use different communication technologies.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An analog recording medium disc comprising:
at least one first face including at least one read layer and at least one first label; and
at least one radio frequency identification device including at least one contactless electronic chip and an antenna printed directly on a face of the at least one label, wherein the at least one label is held within a material that forms the recording medium disc.

2. The recording medium disc according to claim 1, wherein the at least one label has a front face that is visible by a user and a reverse face that is extended over the at least one first face, and the at least one radio frequency identification device is arranged on the reverse face of the at least one label.

3. The recording medium disc according to claim 1, wherein the at least one radio frequency identification device uses a wireless communication technology.

4. The recording medium disc according to claim 3, wherein the wireless communication technology is near field communication.

5. The recording medium disc according to claim 1 further comprising a plurality of radio frequency identification devices, wherein each radio frequency identification device uses a range of different radio frequencies.

6. The recording medium disc according to claim 1, wherein the at least one label is a paper label.

7. The recording medium disc according to claim 1 further comprising a second label that is arranged on a face of the recording medium disc opposite to the at least one first face having the at least one first label, the second label is equipped with an additional radio frequency identification device.

8. The recording medium disc according to claim 1 further comprising a protective case including at least one protective screen that is adapted to inhibit contactless communication between the at least one radio frequency identification device of the at least one first label and an external device.

9. A method for manufacturing a disc according to claim 1, the method comprising:
manufacturing the at least one label by depositing the at least one radio frequency identification device on the at least one label, the depositing comprising:
printing an antenna on the at least one label, and
attaching a contactless electronic chip to the printed antenna;
printing a visual on the at least one label; and
pressing the at least one label with a substrate forming the analog recording medium disc.

10. The method according to claim 9, further comprising controlling and initializing the at least one radio frequency identification device.
